(19) United States
(12) Patent Application Publication
(10) Pub. No.: US 2008/0301958 A1
(43) Pub. Date: Dec. 11, 2008

(54) Calibrated masonry guide line support and method

(76) Inventor: Jerry D. Darty, Jasper, AL (US)

Correspondence Address: TOMAS FRIEND, LLC, 694 CHERRY TREE RD., GURLEY, AL, 35748, US

(21) Appl. No.: 11/811,456

(22) Filed: Jun. 11, 2007

(51) Int. Cl. G01C 15/00; G01C 15/10

(52) U.S. Cl. 33/409; 33/404

(57) ABSTRACT

The present invention is an apparatus and method for guiding the placement of bricks in a wall or facade in which the bricks are placed in a plurality of parallel planes offset by one or more predetermined distances. The apparatus comprises first and second members joined by a pivot or hinge mechanism that allows them to move relative to one another. The first member serves to hold the apparatus to a plumbed post located at the base of the wall or facade to be built and provides a stop for placement of the first brick in a course. The second member comprises a line support, a stop, and a protrusion for moving second member relative to the first member. When the apparatus is held to the post and attached to a line, moving the protrusion of the second member moves the attached line to a preset distance from the post. The use of the apparatus at both ends of a wall building site facilitates the rapid, aligned placement of bricks in a plurality of parallel planes.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATED-BY-REFERENCE OF MATERIAL SUBMITTED ON A COMPACT DISC

Not Applicable

### BACKGROUND OF THE INVENTION

1. Field of the Invention

The present invention relates generally to the art of masonry and is directed to a tool, apparatus, or assembly and corresponding method for guiding the placement of bricks in plumb and horizontal orientations, particularly in the construction of walls and facades having bricks that lie in two or more vertical planes.

2. Description of Related Art

Brick walls and facades are generally built by laying successive courses of brick or stone on top of another. Most commonly, the wall or facade is planar, having no bricks lying out of the plane of the wall. A variety of devices and methods for guiding the placement of bricks in vertical and horizontal directions are provided in the prior art to facilitate the building of planar, or flat walls. Examples of such devices and methods include U.S. Pat. Nos. 3,206,854; 3,791,614; 4,144,649; and 4,359,850, which are incorporated by reference herein in their entirety.

Often, however, brick walls or facades include complex structures such as decorative quoins, projective brick at windows and doors, arches, and solider rowlock that require bricks to be placed in multiple, parallel planes offset by set distances.

U.S. Pat. No. 6,430,826, incorporate herein by reference in its entirety, discloses an apparatus comprising an elongate arm extending in a perpendicular direction from a base plate affixed to a wall. The elongate arm comprises a slot that holds a line support structure that can be fastened at any location in the slot using, for example, a wing nut. The apparatus disclosed in the '826 patent is affixed to a wall and is not designed to be easily moved in a vertical direction to guide the laying of multiple courses of bricks. While the line support can be moved to variable distances from the wall supporting the apparatus, it does not provide for rapid transitions of the line between two or more predetermined positions.

U.S. Pat. No. 6,412,184, incorporated by reference herein in its entirety, discloses a masonry line block adapted for use in combination with a specialized vertical corner pole designed to be used with the block. The '184 invention is disclosed as being useful during the construction corner quoins. The block has no moving parts and comprises two or more guides separated by a predetermined distance to which the user may attach a guide line. Tension on the guide line holds two blocks located on separate corner posts in place, allowing the blocks to be moved in a vertical direction.

The present invention provides an apparatus and method that facilitates the rapid and accurate alignment of bricks in a facing or wall comprising bricks that lie in multiple parallel planes offset by predetermined distances. The apparatus provides advantages over the prior art in several respects. Unlike the '826 invention, the present apparatus can be easily moved in a vertical direction and provides for rapid and accurate movement of the guide line by two or more predetermined distances. Unlike the '184 invention, the present apparatus provides for rapid and accurate movement of the guide line by two or more predetermined distances without manipulating the guide line directly. The tension on a guide line can exceed 100 lbs in some cases, particularly when the distances between corner posts are great. The present invention uses a lever action to move a guide line between two or more predetermined locations relative to the lane defined by two corner posts. The lever action allows the user to move the guide line without applying excessive force. Additional advantages of the present invention over the prior art and advantages over the prior art will become apparent in the following description.

### BRIEF SUMMARY OF THE INVENTION

The present invention is an apparatus and method for guiding the placement of bricks in a wall or facade in which the bricks are placed in a plurality of parallel planes offset by one or more predetermined distances. The apparatus comprises first and second members joined by a pivot or hinge mechanism that allows them to move relative to one another. The first member serves to hold the apparatus to a plumbed post located at the base of the wall or facade to be built and provides a stop for placement of the first brick in a course. The second member comprises a line support, a stop, and a protrusion for moving second member relative to the first member. When the apparatus is held to the post and attached to a line, moving the protrusion of the second member moves the attached line to a preset distance from the post. The use of the apparatus at both ends of a wall building site facilitates the rapid, aligned placement of bricks in a plurality of parallel planes.

### BRIEF DESCRIPTION OF THE SEVERAL VIEWS OF THE DRAWINGS

FIG. 1 is a drawing showing the top view of one embodiment of the apparatus, a square corner post, and an attached guide line.

FIG. 2 is a drawing showing the top view of one embodiment of the apparatus, a square corner post, and an attached guide line in two different positions.

FIG. 3 is a photograph of an embodiment of the apparatus adapted for use with an angle iron post or T-post.

FIG. 4 is a photograph of an embodiment of the apparatus adapted for use with a 2×2 corner post.

FIG. 5 is an end on photograph of an embodiment of the apparatus held on an aluminum 2×2 corner post by tension on a guide line.

### DETAILED DESCRIPTION OF THE INVENTION

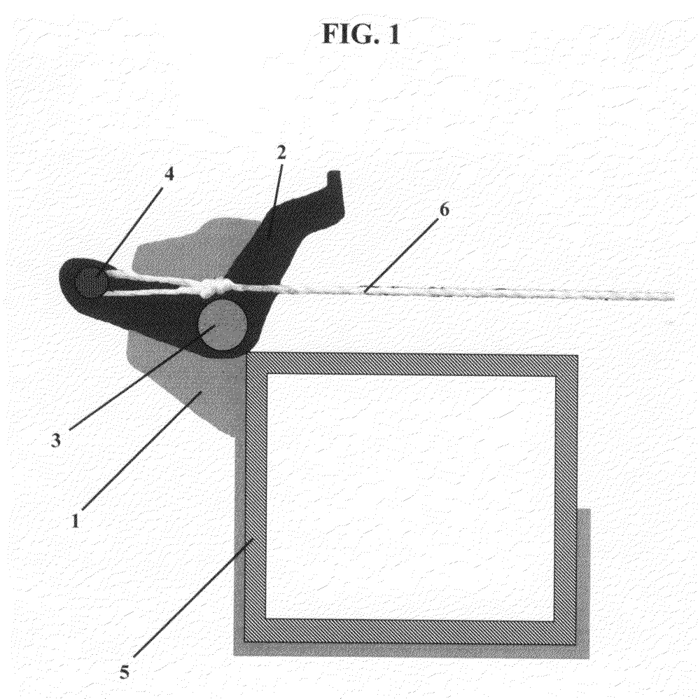

A first embodiment of the calibrated guide line support is shown in FIG. 1. The support comprises a rigid first member 1 connected to a second rigid member 2 though a hinge 3. Rigid member 1 is shaped, in this instance, to conform to the cross-section of a hollow aluminum 2×2 corner post 5. Rigid member 2 comprises a line support 4 to which a guide line 6 has been fastened.

The rigid members, hinge, and line support are preferably made of aluminum, steel, or hard plastic but may be made from any number of materials capable of withstanding the stresses placed on the apparatus during use. The first rigid member 1 may be shaped to conform to a variety of posts or other plumbed masonry guides such as 2×2 inch or other size posts, angle irons, and T-shaped posts. The portion of first member 1 conforming a corner post and the portion attached to second member 2 may be formed from a single piece of metal or plastic, for example, or me be formed by welding two pieces of metal or otherwise fusing or fastening two pieces together. Hinge 3 may be fixed at a single location in members 1 and 2 or may be set in a track with having indentations parallel to the guide line and in the direction of the force applied by a tensioned guide line, enabling the hinge to seat in one of two or more indentations.

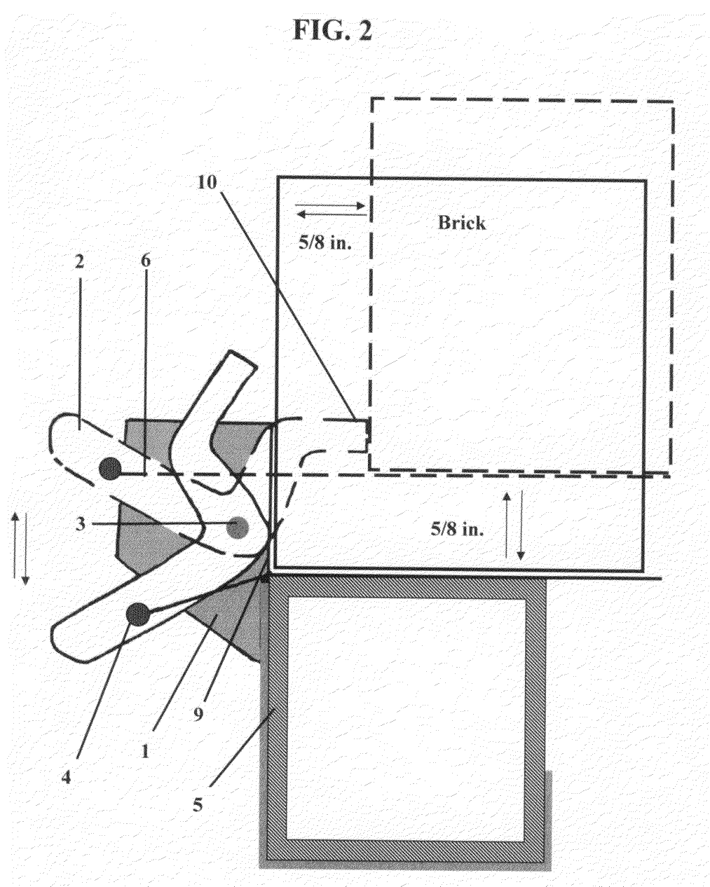

FIG. 2 shows the lever motion of the first embodiment of the calibrated guide line support moving guide line 6 from an initial position against corner post 5 (solid line) to a second position at a predetermined distance from the corner post (dashed line). The reversible movement of the guide line (indicated by opposing arrows) is accomplished by moving the second rigid member 2 relative to stationary rigid member 1 by rotating second member 2 on hinge 3 to move line support 4. The predetermined distance is ⅝ inches in this instance, although other embodiments of the invention may be designed to move the guide line by any desired distance such as 0.33, 0.5, 0.75, 1.0, 1.25, 1.33, 1.5, 1.625, 1.75, and 2 inches. Bricks or blocks are placed using the guide line in one of the two positions (indicated by solid and dashed line boxes). Only the relative positions of brick at the end of a course are shown for clarity. The first member 1 of this embodiment forms a brick stop 9 when the guide line is flush with the corner post. A portion 10 of second member 2 forms a brick stop calibrated to guide the placement of an end brick set in ⅝ inches or other preset distance relative to brick stop 9.

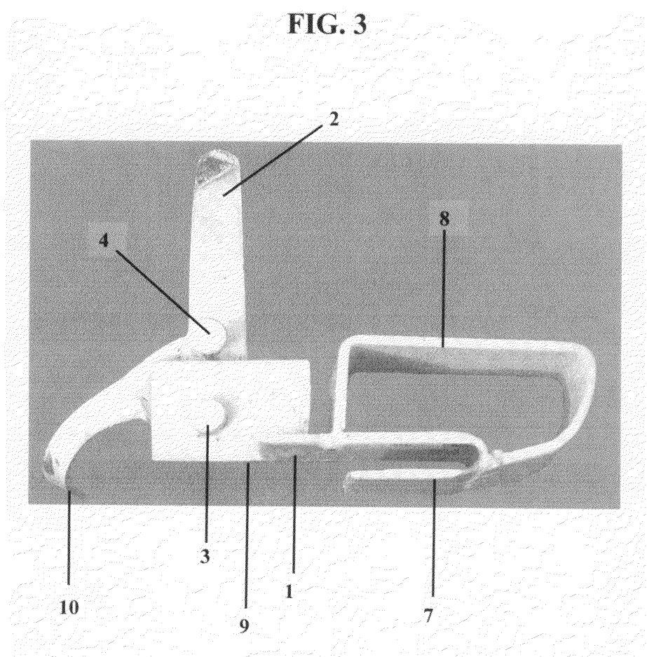

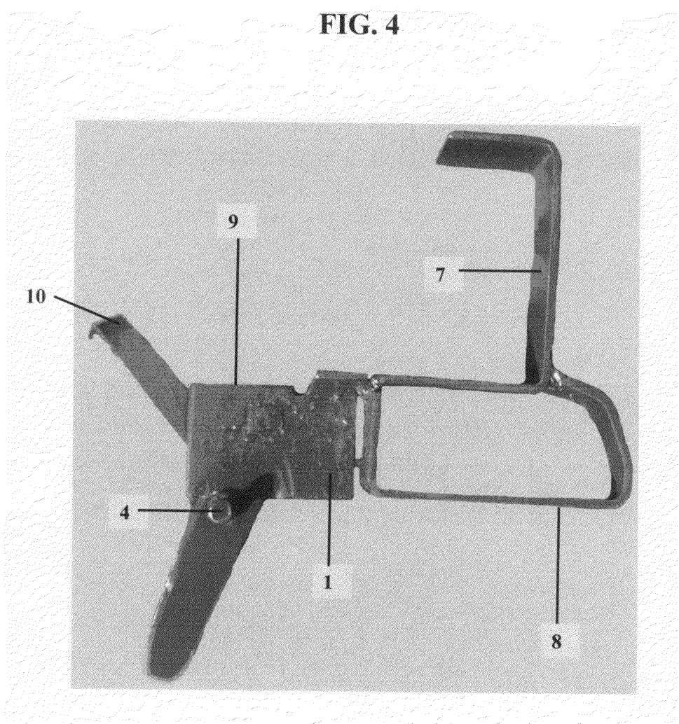

FIG. 3 is a top view photograph of a second embodiment of the calibrated guide line support in which a first region 7 the first member 1 is shaped to conform to the cross-section of an angle iron and a second region 8 of the first member is shaped to form handle to facilitate the movement of the line support in a vertical direction along the angle iron. Also shown are brick stops 9 and 10 formed by portions of members 1 and 2, respectively, pivot 3 joining members 1 and 2, and line support 4. A top view photograph of an embodiment of the invention wherein the first member is adapted for attachment to a 2 in by 2 in corner pole is shown in FIG. 4. The portion of member 1 adapted to conform to the angle iron or corner pole may comprise a flexible material or other means for producing a force adequate to hold the guide line support in place on the corner pole with no guide line attached.

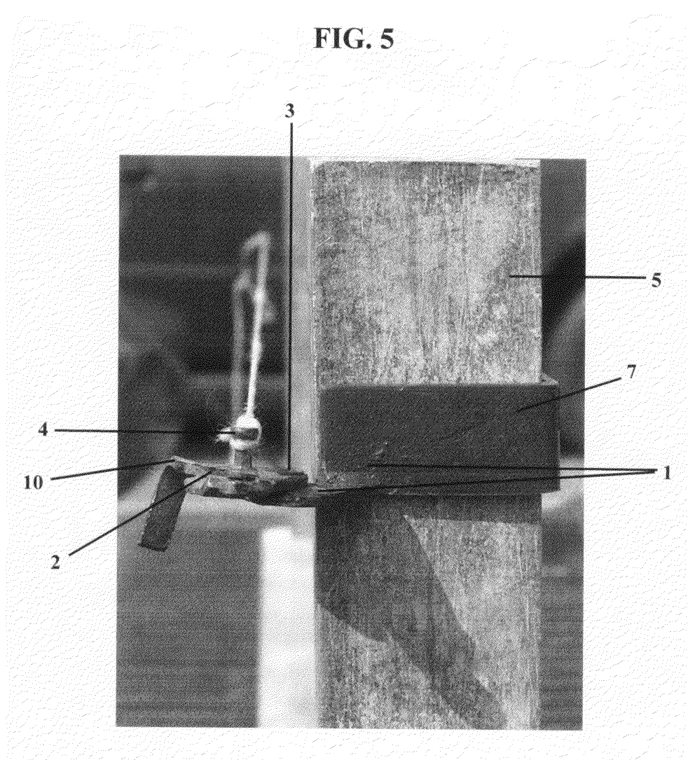

FIG. 5 is an end-on photograph illustrating first guide line support on a first corner pole (foreground and in focus) and attached to a guide line fastened to a second guide line support on a second corner pole (background and not in focus). In this view and for a given course of brick, bricks would be placed to the left of the guideline using the line as a guide. Second member 2 is in a position relative to first member 1 such that line support 4 is located ⅝ inches from 2×2 aluminum corner pole 5. First member 1 may be located above or below second member 2. Placement of first member 1 below second member 2 is preferred, with a portion of second member 2 serving to limit the movement of first member 1 by contacting line support 4 as shown in FIG. 4. Also shown are brick stop 10 and the portion of the second member conforming to the corner pole 7. Reference to particular embodiments of the present invention have been made for the purpose of describing the calibrated masonry guideline support and method. It is not intended that such references be construed as limitations upon the scope of this invention except as set forth in the following claims.

What is claimed is:

1. An apparatus for guiding the placement of bricks in a brick wall comprising rigid first and second members connected by a pivot or hinge having a limited range of motion wherein:
a portion of the first member conforms to the cross-sectional shape of a plumbed, vertical support;
the second member comprises a line support; and
movement of the second member relative to the first member through the limited range of motion of the pivot or hinge moves the line support a predetermined distance in a plane perpendicular to the plumbed, vertical support.

2. The apparatus of claim 1 wherein a portion of the first member forms a stop for guiding the placement of a terminal brick in a course.

3. The apparatus of claim 1 wherein a portion of the second member forms a stop for guiding the placement of a terminal brick in a course.

4. The apparatus of claim 1 wherein a portion of the first member forms a grip or handle.

5. The apparatus of claim 1 wherein the rigid first and second members are connected by a pin or dowel.

6. The apparatus of claim 5 wherein the first member further comprises a slot having indentations separated by predetermined distances such that the pin or dowel connecting the first and second members may be moved predetermined distanced in a direction perpendicular to the plumbed, vertical support.

7. The apparatus of claim 1 wherein the plumbed, vertical support is a corner post, corner pole, angle iron, or t post.

8. The apparatus of claim 1 further comprising a compressible material one interior surface of the portion of the first member conforming to the cross-sectional shape of the plumbed, vertical support.

9. The apparatus of claim 1 wherein the pivot or hinge moves the line support a predetermined distance of 0.33, 0.5, 0.625, 0.75, 1.0. 1.33, 1.5, 1.625, 1.75, or 2.0 inches.

10. A method for guiding the placement of bricks during the construction of a wall wherein the bricks lie in a plurality of parallel vertical planes separated set distances comprising:
placing a plumbed, vertical support at each end of the wall to be constructed;
reversibly fastening an apparatus for guiding the placement of bricks onto each of the two plumbed, vertical supports, the apparatus comprising:
rigid first and second members connected by a pivot or hinge having a limited range of motion wherein:
a portion of the first member conforms to the cross-sectional shape of a plumbed, vertical support;
the second member comprises a line support; and
movement of the second member relative to the first member through the limited range of motion of the pivot or hinge moves the line support a predetermined distance in a plane perpendicular to the plumbed, vertical support;
attaching a line to the two line supports, the line being under a tension sufficient to be approximately straight;
moving the line supports to a first desired, predetermined distance from the plumbed, vertical support;
placing one or more bricks in a course adjacent to the line;
moving the line supports to a second, predetermined distance from the post or angle iron; and
placing one or more bricks in a course adjacent to the line.

11. The method of claim 10 wherein a portion of the first member of the apparatus forms a stop for guiding the placement of a terminal brick in a course.

12. The method of claim 10 wherein a portion of the second member of the apparatus forms a stop for guiding the placement of a terminal brick in a course.

13. The method of claim 10 wherein a portion of the first member of the apparatus forms a grip or handle.

14. The method of claim 10 wherein the rigid first and second members of the apparatus are connected by a pin or dowel.

15. The method of claim 14 wherein the first member of the apparatus further comprises a slot having indentations separated by predetermined distances such that the pin or dowel connecting the first and second members may be moved predetermined distanced in a direction perpendicular to the plumbed, vertical support.

16. The method of claim 10 wherein the plumbed, vertical support is a corner post, corner pole, angle iron, or t post.

17. The method of claim 10 wherein the apparatus further comprising a compressible material one interior surface of the portion of the first member conforming to the cross-sectional shape of the plumbed, vertical support.

18. The method of claim 10 wherein the pivot or hinge of the apparatus moves the line support a distance of 0.33, 0.5, 0.625, 0.75, 1.0, 1.33, 1.5, 1.625, 1.75, or 2.0 inches.
